(19) United States
(12) Patent Application Publication
(10) Pub. No.: US 2026/0268540 A1
(43) Pub. Date: Sep. 10, 2026

(54) DYNAMICALLY GENERATING AND TRANSFORMING DIGITAL COLOR PALETTES BASED ON LIGHT SOURCE COLORS

(71) Applicant: Adobe Inc., San Jose, CA (US)

(72) Inventors: Subhash Chandra Jha, Bangalore (IN); Sarvesh Yadav, Kushinagar (IN)

(21) Appl. No.: 19/072,821

(22) Filed: Mar. 6, 2025

(51) Int. Cl. G06T 11/00; G06F 3/0482; G06T 11/60

(52) U.S. Cl. CPC G06T 11/10; G06F 3/0482; G06T 11/60

(57) ABSTRACT

The present disclosure relates to systems, non-transitory computer-readable media, and methods for dynamically generating and providing customized color palettes based on a light source color. In particular, in one or more embodiments, the disclosed systems provide, via a graphical user interface, a first color palette comprising a first set of colors corresponding to a first light source color. The disclosed systems receive, via the graphical user interface, user input indicating a user selection of a second light source color. The disclosed systems generate, based on the user input and the first set of colors, a second color palette comprising a second set of colors corresponding to the second light source color. The disclosed systems provide, via the graphical user interface and in response to the user input, the second color palette comprising the second set of colors corresponding to the second light source color.

### BACKGROUND

Recent years have seen significant improvements in hardware and software platforms for digital content creation. To illustrate, some software applications generate a variety of digital content, digital designs, and corresponding digital content elements utilizing various colors and generative tools. In many implementations, a light source illuminates some or all of the digital content elements. However, a number of problems exist with conventional systems particularly with regard to flexibility, accuracy, and efficiency of user interfaces and tools for creating and editing colors of design content elements illuminated by a light source.

### BRIEF SUMMARY

Embodiments of the present disclosure provide benefits and/or solve one or more of the foregoing or other problems in the art with systems, non-transitory computer-readable media, and methods for accurately generating and providing color palettes tailored based on a light source. More specifically, in one or more embodiments, the disclosed systems generate or transform a color palette based on a light source color. To illustrate, in some embodiments, the disclosed systems generates a customized color palette by blending a selected light source color from colors in a color palette. Furthermore, in one or more implementations, the disclosed systems provide one or more user interface controls that allow for modifications to a light intensity. In response to a change in a light intensity, the disclosed systems further customize the intensity of the colors of the palette.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a color palette management system operates in accordance with one or more embodiments.

FIG. 2 illustrates a process for generating and providing a customized color palette based on a selected light source color in accordance with one or more embodiments.

FIG. 3 illustrates a process for updating a color palette in response to a selection of an updated light source color in accordance with one or more embodiments.

FIG. 4 illustrates a process for updating the intensity of one or more colors of a color palette in accordance with one or more embodiments.

FIG. 5 illustrates an example graphical user interface providing color palettes modified based on user-selected light sources in accordance with one or more embodiments.

FIG. 6 illustrates a schematic diagram of a color palette management system in accordance with one or more embodiments.

FIG. 7 illustrates a flowchart of a series of acts for generating and providing a color palette based on a selected light source color in accordance with one or more embodiments.

FIG. 8 illustrates a block diagram of an example computing device for implementing one or more embodiments of the present disclosure.

### DETAILED DESCRIPTION

This disclosure describes one or more embodiments of a color palette management system that dynamically generates and modifies graphical user interface color palettes based on user-selected light source colors. More specifically, in one or more embodiments, the color palette management system provides a graphical user interface including a color palette that allows for selection colors for generating or modifying a digital design or image. In some embodiments, in response to receiving user input selecting a light source color, the color palette management system generates an updated version of the color palette by transforming the colors of the palette to appear as though they were lit by the light source color. Further, in one or more embodiments, the color palette management system automatically (e.g., without user input) updates the graphical user interface to include the updated light source color and the corresponding updated color palette.

As mentioned, in one or more embodiments, the color palette management system generates and provides a graphical user interface to a client device that includes a color palette. In one or more embodiments, the color palette management system further generates a graphical user interface that includes a digital design document. In some embodiments, the color palette management system generates the graphical user interface to include the color palette alongside the digital design document. In one or more embodiments, the color palette management system receives a user input selecting a light source color for a color palette. For example, the color palette management system receives the user input via a menu of selectable options for light source colors. In addition, or in the alternative, in one or more embodiments, the color palette management system receives the user input selecting a light source color via user selection of a portion of a digital design document. In such embodiments, the color palette management system determines the color of the digital design document at the location of the user selection and utilizes the selected color as the light source color.

Additionally, in one or more embodiments, the color palette management system generates an updated color palette based on the colors in the first color palette and a selected light source color. To illustrate, in some embodiments, the color palette management system transforms each color in the color palette to appear as though it is lit by the selected light source color and not a first light source color or no light source color. In one or more embodiments, the color palette management system transforms each color to remove a blending of the first light source color (or no light source color) and adds a blending of the updated light source color. Further, in some embodiments, the color palette management system provides the second color palette in the graphical user interface. Indeed, in one or more embodiments, the color palette management system replaces the first color palette with the second color palette.

In some embodiments, the color palette management system also provides a light source intensity bar within the graphical user interface. In one or more embodiments, the color palette management system utilizes user input received via the light source intensity bar to determine a lightness or intensity for a displayed color palette. More specifically, in some embodiments, the color palette management system updates all colors from a displayed color palette based on user input indicating a degree of light source intensity on the light source intensity bar.

Additionally, in one or more embodiments, the color palette management system facilitates editing and/or creation of a digital design document utilizing a customized color palette based on light source color. Further, in one or more embodiments, the color palette management system provides multiple color palettes in the graphical user interface for utilization in creating or modifying a digital design document. In addition, or in the alternative, the color palette management system provides and executes selectable options to toggle between color palettes.

The color palette management system provides many advantages and benefits over conventional systems and methods. Indeed, many conventional systems are inefficient. More specifically, conventional systems require excessive user interaction to select colors, modify colors, and/or designate colors for a color palette. Some conventional systems require repeated navigation through pre-determined palettes in order to select or utilize different colors or different color palettes. Thus, conventional systems require excessive, time, user interactions, user interfaces, and computing resources in generating color palettes for utilization in digital design.

Further, many conventional systems are rigid and inflexible. To illustrate, some conventional systems utilize rigid digital color selection tools that require client devices to choose individual colors to use or to add to a color palette. Moreover, some conventional systems utilize pre-generated color palettes. Although such systems, provide color palettes, the lack of customization fails to provide flexibility for coloring digital designs with different colored light sources or shadowed areas. Specifically, such traditional systems and color palettes fail to adapt to varying lighting conditions or areas of different shades and uses. The rigidity of conventional color palettes often leads to color inconsistencies, wasted time in trial and error due to attempts to manually adjust rigid colors, and often a disconnect between a designer's intent and the final product.

Additionally, conventional systems are inaccurate in generating cohesive colors for utilization in digital design documents. For example, conventional systems that rely on user input to customize individual colors often result in conflicting, inconsistent, or non-optimal color combinations. More specifically, utilizing individual color selection to select colors to simulate different lighting conditions often leads to inconsistent and inaccurate digital design.

The color palette management system provides many advantages over these conventional systems. For example, the color palette management system provides increased efficiency in generating color palettes. To illustrate, by utilizing a single user selection of a light source color to transform a color palette, the color palette management system reduces required user interactions, avoids trial and error associated with conventional systems, and helps ensure an accurate color palette for a light source color. Accordingly, the color palette management system reduces computing time and resources utilized to generate color palettes for light source colors.

Additionally, the color palette management system improves flexibility relative to conventional systems. Indeed, by providing selectable options for light source colors via selection from within a digital design document, the color palette management system provides flexibility in options for color palettes. Further, by adding selectable options to the graphical user interface based on generation of palettes, the color palette management system improves flexibility in creating and editing digital design documents. For example, when a user is working on a digital design with two different light sources or areas that are lit and others that are shadowed, the color palette management system seamlessly provides color palettes customized or adapted to each situation. Thus, the color palette management system utilizes improved graphical user interfaces that provide flexibility for different colors and lighting situations.

Further, the color palette management system generates more accurate color palettes. To illustrate, by utilizing a single user selection of a light source color to transform a color palette, the color palette management system ensures compatibility across the customized color palette. Accordingly, the color palette management system generates color palettes based on a single input that accurately and cohesively aligns to the context of a particular digital design document and input palette. Indeed, the color palette management system allows designers to visualize not only the colors themselves but also the full range of shades and shadows created by adjustable light sources. By providing a more intuitive and dynamic way to explore colors in context, the color palette management system allows designers to make more informed decisions, enhance their creative process, and improve the overall quality of their work.

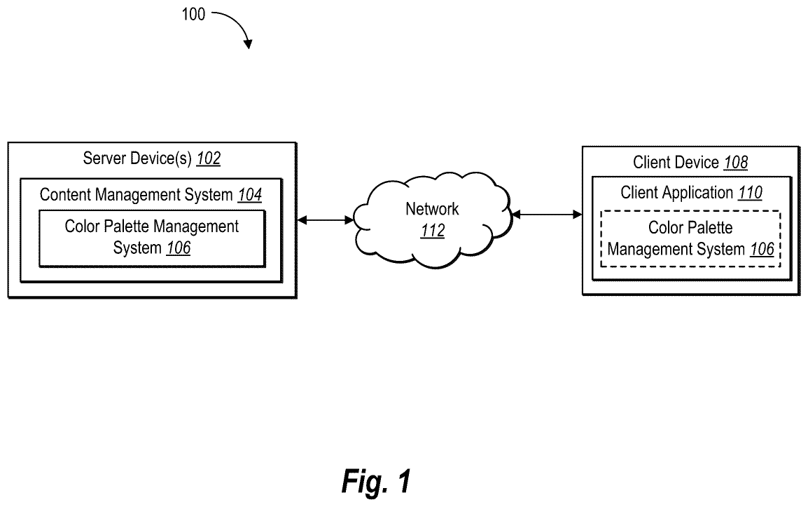

Additional detail will now be provided in relation to illustrative figures portraying example embodiments and implementations of the persona group system. For example, FIG. 1 illustrates a computing system environment (or “environment”) 100 in which a color palette management system operates. As illustrated in FIG. 1, the system 100 includes server device(s) 102, a client device 108, and a network 112.

Although the system 100 of FIG. 1 is depicted as having a particular number of components, the system 100 is capable of having any number of additional or alternative components (e.g., any number of servers, client devices, or other components in communication with the color palette management system 106 via the network 112). Similarly, although FIG. 1 illustrates a particular arrangement of the server device(s) 102, the network 112, and the client device 108 various additional arrangements are possible.

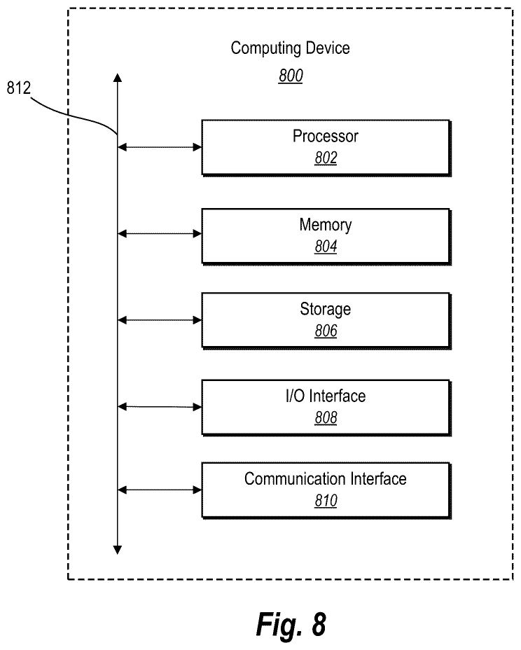

The server device(s) 102, the client device 108, and the network 112 are communicatively coupled with each other either directly or indirectly (e.g., through the network 112 as discussed in greater detail below in relation to FIG. 8). Moreover, the server device(s) 102 and client device 108 include one or more of a variety of computing devices (including one or more computing devices as discussed in greater detail with relation to FIG. 8).

As mentioned above, the system 100 includes the server device(s) 102. In one or more embodiments, the server device(s) 102 generate, store, receive, and/or transmit data including digital data related to user input, input color palettes, custom color palettes, light source colors, digital design documents, etc. In one or more embodiments, the server device(s) 102 comprise a data server. In some implementations, the server device(s) 102 comprise a communication server or a web-hosting server.

In one or more embodiments, the server device(s) 102 include a content management system 104. In some embodiments, the content management system 104 manages the generation, modification, storage, and/or distribution of digital content to client devices (e.g., the client device 108). For example, in some instances, the content management system 104 manages digital content and provides for creation and modification of digital designs utilizing color palettes. In some implementations, the content management system 104 provides digital content for display via one or more digital platforms that are accessed by the client devices.

Additionally, in one or more embodiments, the client devices 108 include computing devices that access digital platforms and/or display digital content. For example, the client device 108 include smartphones, tablets, desktop computers, laptop computers, head-mounted-display devices, or other electronic devices. The client device 108 include one or more applications (e.g., the client application 110) that access digital platforms and/or display digital content. For example, in one or more embodiments, the client application 110 includes a software application installed on the client device 108. Additionally, or alternatively, the client application 110 includes a web browser or other application that accesses a software application hosted on the server device(s) 102 (and supported by the content management system 104).

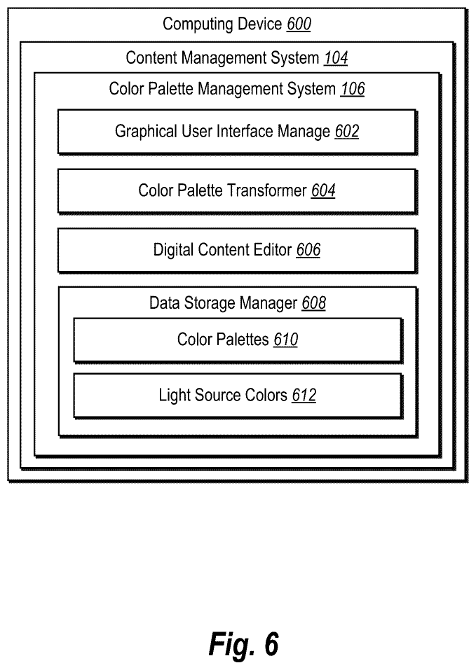

The color palette management system 106 is able to be implemented in whole, or in part, by the individual elements of the system 100. Indeed, although FIG. 1 illustrates the color palette management system 106 implemented with regard to the server device(s) 102 and, optionally, the client device 108, different components of the color palette management system 106 are implemented by a variety of devices within the system 100. For example, in some cases, one or more (or all) components of the color palette management system 106 are implemented by a different computing device (e.g., the client device 108) or a separate server from the server device(s) 102 hosting the content management system 104. Indeed, as shown in FIG. 1, the client device 108 include the color palette management system 106. Example components of the color palette management system 106 will be described below (e.g., with regard to FIG. 6).

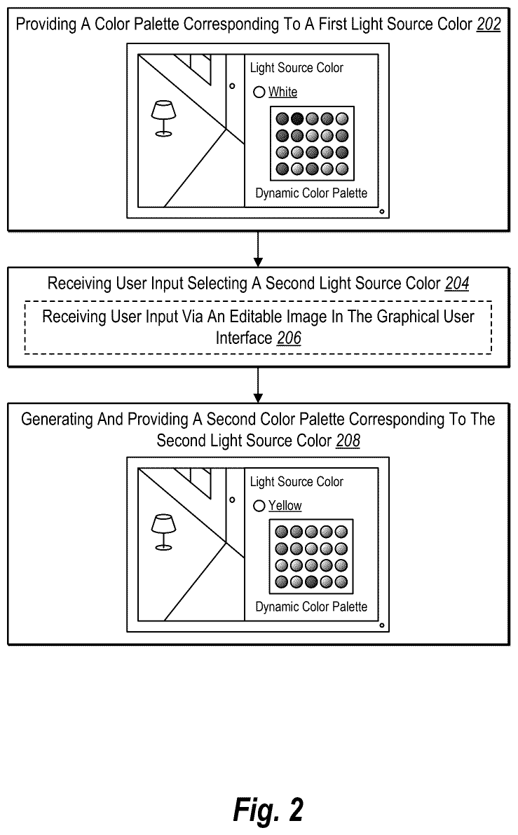

As mentioned above, the color palette management system 106 can generate color palettes based on selected light source colors. Further, the color palette management system 106 can provide the updated color palette within a graphical user interface. FIG. 2 shows an overview of this process.

As shown in FIG. 2, in one or more embodiments, the color palette management system 106 performs an act 202 of providing a color palette corresponding to a first light source color. More specifically, as shown in FIG. 2, the color palette management system 106 generates a graphical user interface including the color palette, an indication of the light source color for the color palette, and a digital design document.

In some embodiments, the color palette management system 106 receives user selection of the first color palette. To illustrate, in some embodiments, the color palette management system 106 receives user selection of individual colors for inclusion in the first color palette. In addition, or in the alternative, in one or more embodiments, the color palette management system 106 receives user selection of an existing color palette as the first color palette. For example, the color palette management system 106 identifies colors already utilized in a digital design document.

In one or more embodiments, a color palette is a set of colors. In particular, a color palette includes a set of colors that are selectable for applying to, or editing, a digital design. In one or more implementations the colors in a color palette are default colors. In another implementation, the colors in a color palette are selected by a user or automatically selected based a digital design being edited or created. Additionally, a customized color palette includes a set of transformed colors based on a light source color or intensity. In one or more embodiments, the color palette management system 106 associates one or more color palettes with a light source color.

In some embodiments, a light source color is a color that appears to provide light for part of a digital design. In one or more embodiments, the color palette management system 106 adds a blending of a light source color to colors in a color palette such that the colors appear to be lit by the light source color. For example, a yellow light source color provides a warm hue to colors within a color palette, such that they appear to be lit by a yellow light.

In one or more embodiments, the color palette management system 106 utilizes a default light source color (or no color) for the first light source color. In addition, or in the alternative, the color palette management system 106 utilizes a user-selected first light source color. Further, in some embodiments, the color palette management system 106 determines a light source color based on the first color palette.

In some embodiments, as also shown in FIG. 2, the color palette management system 106 performs an act 204 of receiving user input selecting a second light source color. In one or more embodiments, the color palette management system 106 receives the user input selecting a light source color via a color selection menu. Additionally, in some embodiments, the color palette management system 106 provides the color selection menu in response to user input at an icon of the currently selected light source color.

For example, in some embodiments, the color palette management system 106 provides a color space or color sliders to facilitate selection of the second light source color. The color palette management system 106 utilizes an organization of a color model (e.g., HSL (hue saturation lightness), HSV (hue saturation value), RGB (red, green, blue), CMYK (cyan magenta, yellow, black), hexachrome, YUV (luminance, blue projection, red projection), or another arrangement of colors).

As shown in FIG. 2, the color palette management system 106 optionally performs an act 206 of receiving user input via an editable image in the graphical user interface. In some embodiments, the editable image is a digital design document. In one or more embodiments, the color palette management system 106 changes the icon corresponding to a cursor to indicate that the color palette management system 106 will receive the next input as selection of the color at the location of the cursor. In some embodiments, the color palette management system 106 changes the cursor in response to user input at the indication of the current light source color.

Thus, in one or more embodiments, the color palette management system 106 receives user selection of a point within an editable image and/or digital design document. Accordingly, in one or more embodiments, the color palette management system 106 determines the color of the editable image and/or digital design document at the selected point. Thus, in some embodiments, the color palette management system 106 utilizes the selected color as a light source color for a second color palette.

Indeed, as shown in FIG. 2, the color palette management system 106 performs an act 208 of generating and providing a second color palette corresponding to the second light source color. Indeed, in one or more embodiments, the color palette management system 106 transforms each color from the first color palette utilizing the second light source color. Accordingly, the color palette management system 106 generates the second color palette to appear as though the first color palette is lit by the second light source.

Further, the color palette management system 106 provides the generated second color palette within the graphical user interface. Accordingly, the color palette management system 106 facilitates editing of the editable image and/or digital design document utilizing the second color palette. In one or more embodiments, the color palette management system 106 provides multiple color palettes via the graphical user interface. In addition, or in the alternative, the color palette management system 106 provides selectable options for toggling between color palettes and/or light source colors. Thus, the color palette management system 106 provides a graphical user interface that allows seamless and efficient color navigation to generate digital design documents that illustrate a variety of lighting conditions across the same environment.

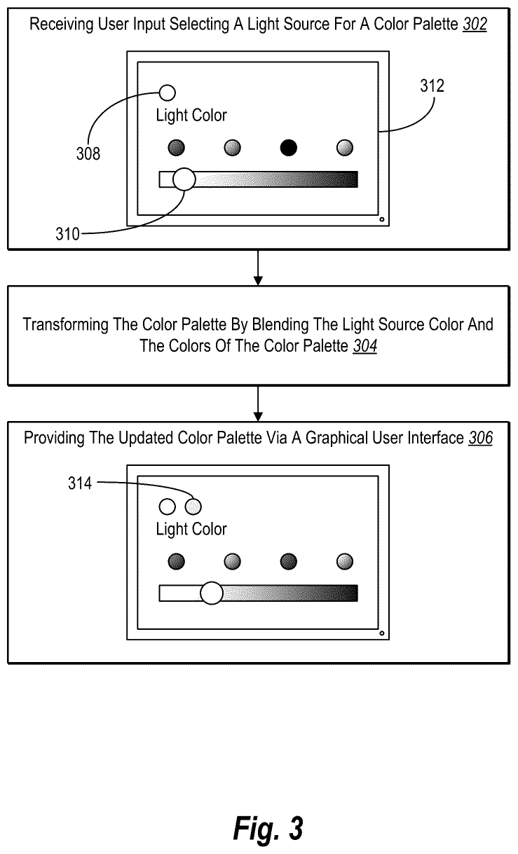

In some embodiments, the color palette management system 106 generates color palettes for selected light source colors by transforming the colors in a color palette. FIG. 3 illustrates a process for generating an updated color palette based on receiving a selection of a light source color. To illustrate, as shown in FIG. 3, the color palette management system 106 performs an act 302 of receiving user input selecting a light source color for a color palette. As shown in FIG. 3, the color palette management system 106 receives user input selecting a light source color for a color palette of four colors.

As mentioned above, in one or more embodiments, the color palette management system 106 receives user input via a color selection menu. In addition, or in the alternative, the color palette management system 106 receives the user input selecting the light source color via an editable image and/or digital design document. In one or more embodiments, the color palette management system 106 generates a second color palette based on the first color palette and the selected light source color.

More specifically, in one or more implementations, in response to a selection of the light source icon 308 in the color palette graphical user interface 310, the color palette management system 106 activates a color selector slider 312. In response to movement of the color selector slider 312, the color palette management system 106 selects a corresponding light color. In alternative implementations, in response to a selection of the light source icon 308 in the color palette graphical user interface 310, the color palette management system 106 receives a user selection of a location in digital design. In response to a selection of a location in the digital design, the color palette management system 106 automatically selects a light color corresponding to the color of the pixels in the location selected by the user.

As shown in FIG. 3, the color palette management system 106 performs an act 304 of transforming the color palette by blending the light source color with the colors of the color palette. In one or more implementations, act 304 involves removing a blending of a prior light source color and adding a blending of the selected light source color. In alternative implementations, act 304 involves blending the blending the light source color with the colors of the color palette, which had no associated light source color previously. In any event, the color palette management system 106 transforms each of the colors in a color palette to appear to be illuminated by the selected light source color. Therefore, the color palette management system 106 modifies each color in a color palette based on a single user interaction (e.g., the selection of the light source color). Accordingly, the color palette management system 106 generates accurately coordinating color palettes for particular light source colors based on a single user interaction. As such, the color palette management system 106 does not require any other user selection or interaction. Further, the color palette management system 106 facilitates efficient navigation among color palettes generated based on a single user interaction.

In one or more embodiments, the color palette management system 106 utilizes a color blending algorithm to transform the colors. For example, in some embodiments, the color palette management system 106 utilizes a multiply blending algorithm. To illustrate, the color palette management system 106 takes red-green-blue channel values from 0 to 1 for each color from the color palette and multiplies them with the values of the light source color. Further, in some embodiments, the color palette management system 106 also utilizes a multiply blending algorithm to remove a blending of a prior light source color by dividing the red-green-blue channel values from 0 to 1 for each color from the color palette by the values of the prior light source color. Alternatively, the color palette management system 106 also utilizes a screening blending algorithm to remove a blending of a prior light source color by inverting the red-green-blue channel values from 0 to 1 for each color from the color palette and multiplying by the values of the prior light source color. In alternative implementations, the color palette management system 106 blends colors in the CMYK color space and utilizes a substrative blending algorithm. In still further implementations, the color palette management system 106 utilizing an overlay blending technique or other blending technique.

As shown in FIG. 3, in one or more implementations, the color palette management system 106 performs an act 306 of providing the updated color palette via the graphical user interface. As shown in FIG. 3, the color palette management system 106 updates a graphical user interface to include the updated color palette based on the selected light source color. Further, the color palette management system 106 has removed the prior color palette. However, in some embodiments, the color palette management system 106 provides multiple generated palettes alongside one another within the graphical user interface for simultaneous use.

As also shown in FIG. 3, in one or more implementations, the color palette management system 106 adds a selectable light color option 314 for the previous light source color. In response to selection of the selectable light color option 314, the color palette management system 106 surfaces the previous color palette associated with the first light source color (which may be no color). In one or more embodiments, the color palette management system 106 adds a selectable option to the graphical user interface in response to generating each new color palette for each new light source color.

In one or more embodiments, in response to receiving user input at either of the selectable options for the light source colors within the graphical user interface, the color palette management system 106 toggles between the color palettes corresponding to the light source colors. To illustrate, upon receiving user interaction at the selectable option 314 corresponding to the prior light source color, the color palette management system 106 modifies the graphical user interface to include the color palette corresponding to the prior light source color. Thus, the color palette management system 106 facilitate generation or editing of digital design documents with various color palettes for a variety of lighting conditions.

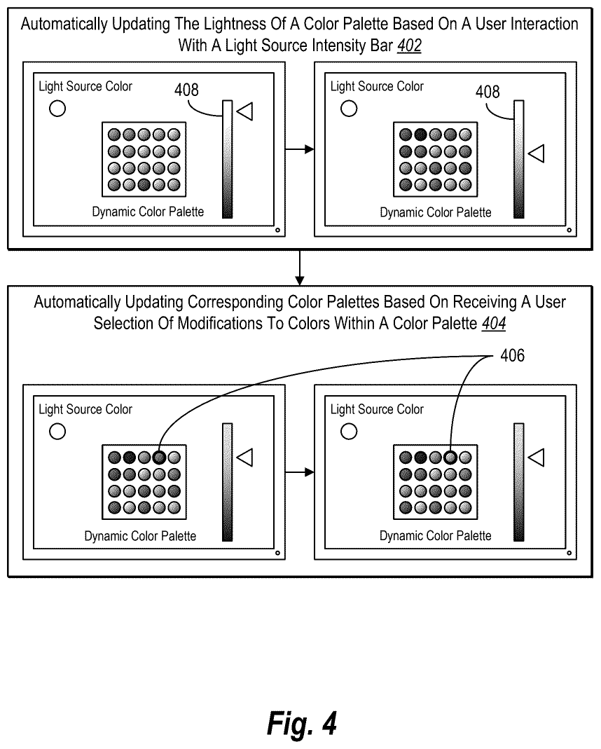

In addition to customizing a color palette based on a light source color, the color palette management system 106, in one or more implementations, customizes color palettes based on one or more color attributes. For example, the color palette management system 106 adjusts color palettes based on light intensity, hue, saturation, or luminosity. FIG. 4 illustrates the color palette management system 106 generating customized color palettes based on a selected light intensity. In alternative implementations, the color palette management system 106 generates customized color palettes based on a selected hue, saturation, or luminosity in a similar manner.

As shown in FIG. 4, in one or more implementations, the color palette management system 106 performs an act 402 of automatically updating the lightness or brightness of a color palette based on user interaction with a light source intensity bar 408. As shown in FIG. 4, the color palette management system 106 generates a graphical user interface including a color palette and light source intensity bar 408. As shown in FIG. 4, in one or more implementations, the light source intensity bar comprises a slider bar showing a lightness gradient. In alternative implementations, the color palette management system 106 generates the light source intensity bar as a number bar, a value box, or other type of graphical user interface element.

Further, based on user interaction with the light source intensity bar, the color palette management system 106 modifies the lightness of each color in a color palette. For example, as shown in FIG. 4, the color palette management system 106 decreases the lightness of each color in the color palette based on the user interaction selecting a lower lightness on the light source intensity bar 408. Thus, the color palette management system 106 adjusts the color palette to reflect an amount of light indicated by the user interaction at the light source intensity bar 408. Accordingly, the color palette management system 106 modifies the lightness of the colors in a color palette based on a single user interaction.

As also shown in FIG. 4, the color palette management system 106 performs an act 404 of automatically updating corresponding color palettes based on user selection of modifications to colors within a color palette. For example, as shown in FIG. 4, the color palette management system 106 receives user input modifying the hue, saturation, or lightness of a color 406 within the displayed color palette via a corresponding intensity bar. In one or more embodiments, the color palette management system 106 receives the updated hue, saturation, or lightness for a color 406 in the color palette based on received user input via a color selection menu. In addition, or in the alternative, the color palette management system 106 receives the user input selecting the updated hue, saturation, or lightness for the color 406 via an editable image and/or digital design document.

In one or more embodiments, based on the user selection of an updated hue, saturation, or lightness for the color 406, the color palette management system 106 identifies each color palette in the family of the modified color palette. To illustrate, the color palette management system 106 identifies each color palette that was generated, directly or indirectly, by selecting an updated light source color from a particular source palette. In one or more embodiments, this color palette family includes any color palette generated by determining an updated light source color from another member of the color palette family.

Further, in some embodiments, the color palette management system 106 makes a corresponding transformation to the hue, saturation, or lightness of the modified color for each palette in the color palette family. To illustrate, the color palette management system 106 makes the same transformation to each of the colors that correspond to the color 406 in their respective palettes. Thus, the color palette management system 106 promulgates changes such that each color palette in the color palette family includes a corresponding color to color 406 that appears to be lit by the corresponding light source color. That is, rather than placing the color 406 in each color palette, the color palette management system 106 generates a version of color 406 that appears to be lit by the appropriate light source color for each color palette.

Thus, the color palette management system 106 promulgates changes across palettes based on a single user interaction. In embodiments where the color palette management system 106 generates a graphical user interface that displays multiple color palettes from a color palette family at once, the color palette management system 106 modifies the visual representations of the color palettes in real time. In embodiments where the color palette management system 106 provides selectable options to toggle between light source colors, the color palette management system 106 shows the updated corresponding color for a color palette upon selection or re-selection of the color palette for presentation.

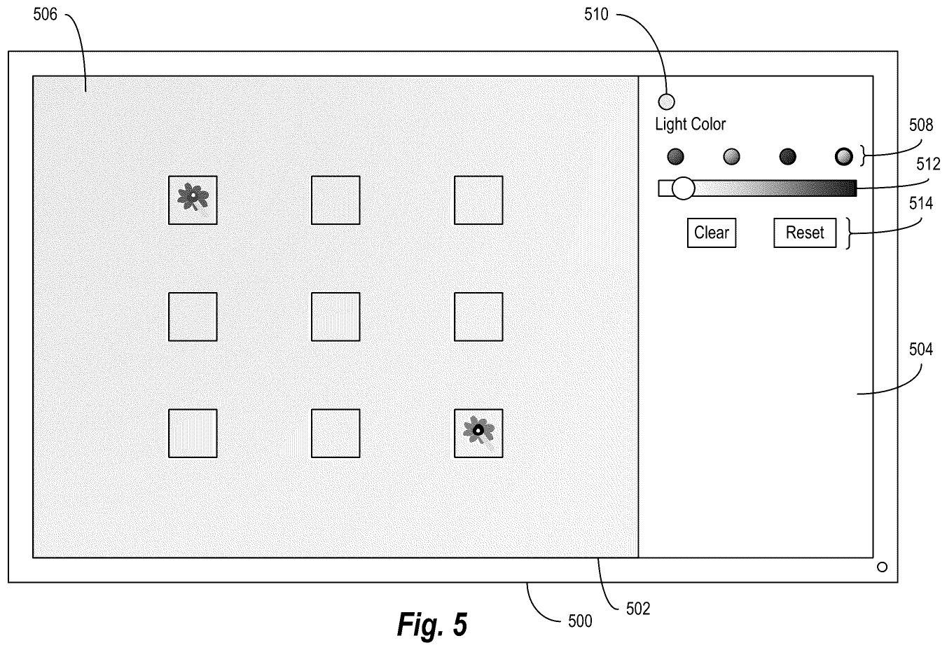

In one or more embodiments, the color palette management system 106 generates and manages a graphical user interface for generating, modifying, and utilizing color palettes. FIG. 5 illustrates an example graphical user interface for generating, modifying, and utilizing color palettes. More specifically, FIG. 5 illustrates a client device 500 displaying an example graphical user interface 502 that includes a color palette panel 504 and a digital design document 506.

As shown in FIG. 5, the graphical user interface 502 includes a color palette panel 504. Further, as shown in FIG. 5, the color palette management system 106 generated the color palette panel 504 to include a color palette 508 of four colors. However, it will be appreciated that the color palette management system 106, in other implementations, generates and manages color palettes of various sizes (e.g., numbers of colors).

Additionally, the color palette management system 106 generates the color palette panel 504 including a color palette indicator 510 that includes the light source color that corresponds to the color palette 508. In one or more embodiments, based on user interaction at the color palette indicator 510, the color palette management system 106 provides options for selecting an updated light source color. As discussed above with regard to FIG. 2, the color palette management system 106, in one or more implementations, receives user input indicating an updated light source color via a selectable menu and/or via user interaction with an editable image or digital design document.

To illustrate, in one or more embodiments, the color palette management system 106 receives user input via the digital design document 506. As shown in FIG. 5, the digital design document 506 includes squares and two flowers across a color gradient. However, it will be appreciated that the color palette management system 106 is able to facilitate generation and modification to a variety of editable images and digital design documents. In one or more embodiments, the color palette management system 106 changes the icon corresponding to a cursor to indicate that the color palette management system 106 will receive the next user interaction (e.g., a click) within the digital design document 506 as selection of the color at the location of the cursor.

As also shown in FIG. 5, the color palette management system 106 generates the color palette panel 504 including a light source intensity bar 512. As discussed above with regard to FIG. 4, in one or more embodiments, the color palette management system 106 modifies each color in the color palette 508 based on user interaction at the light source intensity bar 512. To illustrate, the color palette management system 106 modifies the lightness of the colors in the color palette 508 based on the indicated lightness along the light source intensity bar 512.

In some embodiments, the color palette management system 106 modifies only the lightness of the colors in the color palette 508 based on the indicated lightness along the light source intensity bar 512. In addition, or in the alternative, the color palette management system 106 modifies the intensity of the blending of the light source color in the colors of the color palette 508 based on the indicated lightness along the light source intensity bar 512. Accordingly, the color palette management system 106 simulates closeness to, or intensity of, a light source utilizing the light source intensity bar 512. For example, an object very near to a yellow light bulb may appear not just brighter, but also warmer and more yellow.

As shown in FIG. 5, the color palette management system 106, in one or more implementations, generates the color palette panel 504 including color palette options 514. More specifically, the color palette options 514 include a clear button and a reset button. In one or more embodiments, based on user interaction with the clear button, the color palette management system 106 undoes any changes or modifications made to the color palette 508. Additionally, in some embodiments, based on user interaction with the reset button, the color palette management system 106 resets the color palette 508 to its initial state and/or initial settings.

In some embodiments, the color palette management system 106 facilitates editing or generation of digital content utilizing various colors from generated color palettes. For example. the color palette management system 106 facilitates use of the color palette 508 in editing the digital design document 506. Further, the color palette management system 106 generates, provides, and toggles between color palettes for light source colors found in the color gradient of the digital design document 506.

Turning to FIG. 6, additional detail will be provided regarding exemplary components 602-608 of the color palette management system 106. Each of the components 602-608 of the color palette management system 106 include software, hardware, or both. For example, the components 602-608 include one or more instructions stored on a computer-readable storage medium and executable by processors of one or more computing devices, such as a client device or server device. When executed by the one or more processors, the computer-executable instructions of the color palette management system 106 cause the computing device(s) to perform the methods described herein. Alternatively, the components 602-608 include hardware, such as a special-purpose processing device to perform a certain function or group of functions. Alternatively, the components 602-608 of the color palette management system 106 include a combination of computer-executable instructions and hardware.

As shown in FIG. 6, the content management system 104 and the color palette management system 106 are implemented via a computing device 600 (e.g., the server device(s) 102 and/or the client device 108). In one or more embodiments, the color palette management system 106 includes a graphical user interface manager 602. In one or more embodiments, the graphical user interface manager 602 tracks user inputs and manages presentation of color palettes. In addition, in some embodiments, the graphical user interface manager 602 manages selections of light source colors.

As also shown in FIG. 6, the color palette management system 106 also includes a color palette transformer 604. In one or more embodiments, the color palette transformer 604 transforms colors to generate color palettes corresponding to selected light source colors. In one or more embodiments, the color palette transformer 604 includes a color blending algorithm. For example, in some embodiments, the color palette transformer 604 includes a multiply blending algorithm.

Additionally, as shown in FIG. 6, the color palette management system 106 includes a digital content editor 606. In one or more embodiments, the digital content editor 606 manages creation and modification of digital content, including digital images and/or digital design documents. In some embodiments, the digital content editor 606 manages and interprets user inputs utilizing different color palettes.

In some embodiments, the color palette management system 106 also includes the data storage manager 608. The data storage manager 608 maintains data for the color palette management system 106. The data storage manager 608 (e.g., via one or more memory devices) maintains data of any type, size, or kind, as necessary to perform the functions of the color palette management system 106. For example, the data storage manager 608 includes color palettes 610 and light source colors 612.

Furthermore, the components 602-608 of the color palette management system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 602-608 may be implemented as a stand-alone application, such as a desktop or mobile application. Furthermore, the components 602-608 may be implemented as one or more web-based applications hosted on a remote server. The components 602-608 may also be implemented in a suite of mobile device applications or “apps.”

To illustrate, the components 602-610 may be implemented in an application, including but not limited to ADOBE FRESCO, ADOBE PHOTOSHOP, ADOBE PHOTOSHOP EXPRESS, ADOBE PHOTOSHOP LIGHTROOM, ADOBE ILLUSTRATOR, ADOBE ANIMATE, and ADOBE AFTER EFFECTS. The foregoing are either registered trademarks or trademarks of Adobe Inc. in the United States and/or other countries.

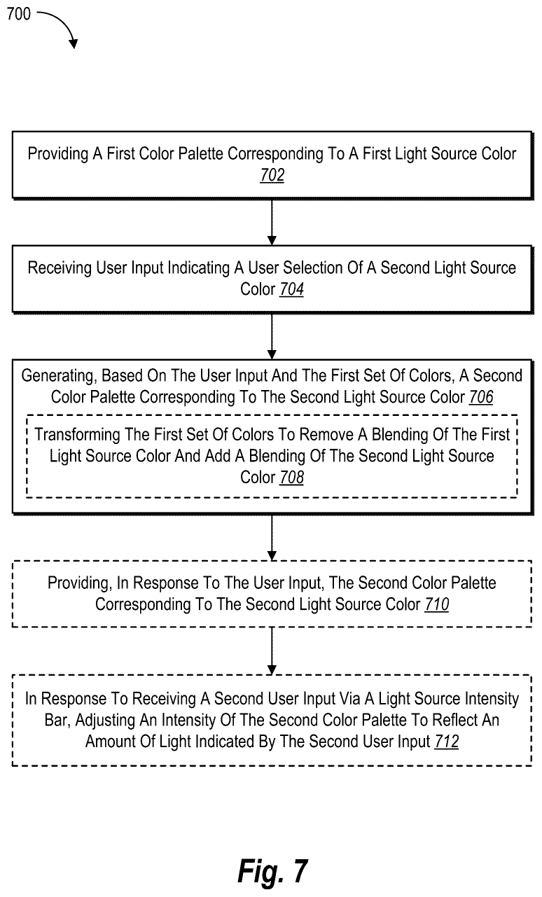

FIGS. 1-6, the corresponding text, and the examples provide a number of different methods, systems, devices, and non-transitory computer-readable media of the color palette management system 106. In addition to the foregoing, one or more embodiments are described in terms of flowcharts comprising acts for accomplishing a particular result, as shown in FIG. 7. The methods of FIG. 7 are performable with more or fewer acts. Further, the acts are performable in differing orders. Additionally, the acts described herein are repeatable or performable in parallel with one another or parallel with different instances of the same or similar acts.

As mentioned, FIG. 7 illustrates a flowchart of a series of acts 700 for generating and utilizing a custom color palette in accordance with one or more embodiments. The acts of FIG. 7 are performable as part of a method. Alternatively, a non-transitory computer-readable medium comprises instructions that, when executed by one or more processors, cause a computing device to perform the acts of FIG. 7. In some embodiments, a system performs the acts of FIG. 7.

As shown in FIG. 7, the series of acts 700 includes an act 702 for providing a first color palette corresponding to a first light source color. More specifically, in one or more implementations, the act 702 includes providing, via a graphical user interface, a first color palette comprising a first set of colors corresponding to a first light source color. Additionally, the series of acts 700 includes an act 704 for receiving user input indicating a user selection of a second light source color. More specifically, in one or more implementations, the act 704 includes receiving, via the graphical user interface, user input indicating a user selection of a second light source color. Further, the series of acts 700 includes an act 706 for generating, based on the user input and the first set of colors, a second color palette corresponding to the second light source color. More specifically, in one or more implementations, the act 706 includes generating, based on the user input and the first set of colors, a second color palette comprising a second set of colors corresponding to the second light source color.

The series of acts 700 also includes an optional act 708 of transforming the first set of colors to remove a blending of the first light source color and add a blending of the second light source color. More specifically, the optional act 708, in one or more implementations, includes generating, based on the user input and the first set of colors, a second color palette comprising a second set of colors corresponding to the second light source color by transforming the first set of colors to remove a blending of the first light source color and add a blending of the second light source color. Further, the series of acts 700 includes an optional act 710 of providing, in response to the user input, the second color palette corresponding to the second light source color. More specifically, in one or more implementations, the optional act 710 includes providing, via the graphical user interface and in response to the user input, the second color palette comprising the second set of colors corresponding to the second light source color.

Additionally, the series of acts 700 includes an optional act 712 of in response to receiving a second user input via a light source intensity bar, adjusting an intensity of the second color palette to reflect an amount of light indicated by the second user input. More specifically, in one or more implementations, the optional act 712 includes, in response to receiving a second user input via a light source intensity bar, adjusting an intensity of the second set of colors of the second color palette to reflect an amount of light indicated by the second user input.

In one or more embodiments, the series of acts 700 also includes receiving additional user input indicating a modification to a hue, saturation, or lightness of a color from the second set of colors. Such implementations, involve based on the additional user input, automatically updating the color from the second set of colors and automatically updating a corresponding color from the first set of colors. In some embodiments, the series of acts 700 further includes providing, via the graphical user interface, a selectable option for the first light source color and the second light source color, and in response to receiving additional user input indicating user selection of the first light source color, providing the first color palette via the graphical user interface.

In some embodiments, the series of acts 700 also includes providing, via the graphical user interface, one or more selectable options corresponding to light source colors. For example, the user input comprises a selection of a selectable option of the one or more selectable options. Additionally, the series of acts 700, in one or more implementations, includes providing, via the graphical user interface, an editable digital design document. In one or more implementations, receiving the user input indicating the user selection of the second light source color comprises receiving user selection of the second light source color from the editable digital design document.

Further, the series of acts 700, in one or more implementations, includes facilitating edits to the editable digital design document utilizing the second set of colors from the second color palette. The series of acts 700 also includes, in one or more implementations, in response to receiving a second user input at a light source intensity bar, adjusting the second color palette to reflect an amount of light indicated by the second user input. Additionally, in some embodiments, the series of acts 700 includes generating the second set of colors corresponding to the second light source color by transforming the first set of colors based on the second light source color.

The series of acts 700 also includes, in one or more implementations, receiving additional user input indicating a modification to a hue or saturation of a color from the second set of colors, and based on the additional user input, automatically updating the color from the second set of colors and automatically updating a corresponding color from the first set of colors. In one or more embodiments, the series of acts 700 also includes providing, via the graphical user interface, a selectable option for a first light source color and the second light source color. In response to receiving user input indicating the user selection of the first light source color, the acts 700 include providing the first set of colors in a first color palette via the graphical user interface and removing the second color palette from the graphical user interface.

In one or more embodiments, a series of acts receiving, via a graphical user interface, user input indicating a user selection of a light source color. In some embodiments, the series of acts further includes generating, based on the user input, a color palette comprising a set of colors are blended with the light source color. In such implementations, the series of acts includes providing, via the graphical user interface and in response to the user input, the color palette. The series of acts also includes, in one or more implementations, in response to receiving a second user input via a light source intensity bar, adjusting an intensity of the set of colors of the color palette to reflect an amount of light indicated by the second user input.

In one or more embodiments, the series of acts further includes receiving additional user input indicating a modification to a hue or saturation of a color from the set of colors. Such implementations also include based on the additional user input, automatically updating the color from the set of colors to reflect the modification to the hue or saturation. The series of acts also includes providing, via the graphical user interface, a selectable option for an additional light source color and the light source color. In response to receiving the user input indicating the user selection of the additional light source color, the acts involve providing a second color palette colored according to the additional light source color via the graphical user interface and removing the color palette from the graphical user interface.

In one or more embodiments, the series of acts 700 further includes providing, via the graphical user interface, or more selectable options to modify a hue or saturation of a color. In some embodiments, the series of acts also includes providing, via the graphical user interface, an editable digital design document. In such implementations, receiving the user input indicating the user selection of the light source color comprises receiving user selection of the light source color from the editable digital design document via the graphical user interface. Additionally, in one or more embodiments, the series of acts includes generating the set of colors corresponding to the light source color by applying a color blending algorithm to a first set of colors to add the light source color.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., computing device 600, server device(s) 102, and client device 108. In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
providing, via a graphical user interface, a first color palette comprising a first set of colors corresponding to a first light source color;
receiving, via the graphical user interface, user input indicating a user selection of a second light source color;
generating, based on the user input and the first set of colors, a second color palette comprising a second set of colors corresponding to the second light source color; and
providing, via the graphical user interface and in response to the user input, the second color palette comprising the second set of colors corresponding to the second light source color.

2. The method of claim 1, further comprising:
receiving additional user input indicating a modification to a hue, saturation, or lightness of a color from the second set of colors; and
based on the additional user input, automatically updating the color from the second set of colors and automatically updating a corresponding color from the first set of colors.

3. The method of claim 1, further comprising:
providing, via the graphical user interface, a selectable option for the first light source color and the second light source color; and
in response to receiving additional user input indicating user selection of the first light source color, providing the first color palette via the graphical user interface.

4. The method of claim 1, further comprising providing, via the graphical user interface, one or more selectable options corresponding to light source colors, wherein the user input comprises a selection of a selectable option of the one or more selectable options.

5. The method of claim 1, further comprising providing, via the graphical user interface, an editable digital design document;
wherein receiving the user input indicating the user selection of the second light source color comprises receiving user selection of the second light source color from the editable digital design document.

6. The method of claim 5, further comprising facilitating edits to the editable digital design document utilizing the second set of colors from the second color palette.

7. The method of claim 1, further comprising, in response to receiving a second user input at a light source intensity bar, adjusting the second color palette to reflect an amount of light indicated by the second user input.

8. The method of claim 1, further comprising generating the second set of colors corresponding to the second light source color by transforming the first set of colors based on the second light source color.

9. A non-transitory computer-readable medium comprising instructions that, when executed by a processing device, cause the processing device to perform operations comprising:
receiving, via a graphical user interface, user input indicating a user selection of a light source color;
generating, based on the user input, a color palette comprising a set of colors are blended with the light source color;
providing, via the graphical user interface and in response to the user input, the color palette; and
in response to receiving a second user input via a light source intensity bar, adjusting an intensity of the set of colors of the color palette to reflect an amount of light indicated by the second user input.

10. The non-transitory computer-readable medium of claim 9, wherein the operations further comprise:
receiving additional user input indicating a modification to a hue or saturation of a color from the set of colors; and
based on the additional user input, automatically updating the color from the set of colors to reflect the modification to the hue or saturation.

11. The non-transitory computer-readable medium of claim 9, wherein the operations further comprise:
providing, via the graphical user interface, a selectable option for an additional light source color and the light source color; and
in response to receiving user input indicating the user selection of the additional light source color, providing a second color palette colored according to the additional light source color via the graphical user interface and removing the color palette from the graphical user interface.

12. The non-transitory computer-readable medium of claim 9, wherein the operations further comprise providing, via the graphical user interface, one or more selectable options to modify a hue or saturation of a color.

13. The non-transitory computer-readable medium of claim 9, wherein the operations further comprise providing, via the graphical user interface, an editable digital design document;
wherein receiving the user input indicating the user selection of the light source color comprises receiving user selection of the light source color from the editable digital design document via the graphical user interface.

14. The non-transitory computer-readable medium of claim 9, wherein the operations further comprise generating the set of colors corresponding to the light source color by applying a color blending algorithm to a first set of colors to add the light source color.

15. A system comprising:
a memory component; and
one or more processing devices coupled to the memory component, the one or more processing devices to perform operations comprising:
providing, via a graphical user interface, a first color palette comprising a first set of colors corresponding to a first light source color;
receiving, via the graphical user interface, user input indicating a user selection of a second light source color;
generating, based on the user input and the first set of colors, a second color palette comprising a second set of colors corresponding to the second light source color by transforming the first set of colors to remove a blending of the first light source color and add a blending of the second light source color; and
providing, via the graphical user interface and in response to the user input, the second color palette comprising the second set of colors corresponding to the second light source color.

16. The system of claim 15, wherein the operations further comprise:
receiving a second user input indicating a modification to a hue, saturation, or lightness of a color from the second set of colors; and
based on the second user input, automatically updating the color from the second set of colors and automatically updating a corresponding color from the first set of colors.

17. The system of claim 16, wherein the operations further comprise:
providing, via the graphical user interface, a selectable option for the first light source color and the second light source color; and
in response to receiving a third user input indicating user selection of the first light source color, providing the first color palette via the graphical user interface.

18. The system of claim 15, wherein the operations further comprise:
providing, via the graphical user interface, one or more selectable options corresponding to light source colors; and
adding to the graphical user interface, in response to the user input, selectable options corresponding to the second light source color.

19. The system of claim 15, wherein the operations further comprise providing, via the graphical user interface, an editable digital design document;
wherein receiving the user input indicating the user selection of the second light source color comprises receiving user selection of the second light source color from the editable digital design document.

20. The system of claim 15, wherein the operations further comprise, in response to receiving a second user input at a light source intensity bar, adjusting the first color palette to reflect an amount of light indicated by the second user input.
